(19) United States
(12) Patent Application Publication
(10) Pub. No.: US 2021/0110733 A1
(43) Pub. Date: Apr. 15, 2021

(54) Enhance Writer Tool

(71) Applicant: Andrew Buckmire, North Brunswick, NJ (US)

(72) Inventor: Andrew Buckmire, North Brunswick, NJ (US)

(21) Appl. No.: 16/997,874

(22) Filed: Aug. 19, 2020

Related U.S. Application Data
(60) Provisional application No. 62/868,374, filed on Jun. 28, 2019.

(51) Int. Cl. G09B 11/04; G09B 17/00

(52) U.S. Cl. CPC G09B 11/04; B42D 15/0006; G09B 17/00

(57) ABSTRACT

Implemented is an enhance writer tool that can be used for young children while learning to read and write alpha-numeric symbols. The enhance writer tool is a flat panel that has various alpha-numeric insignia on both sides, a front and rear side. The enhance writer tool includes an opening in the middle portion that can be used for a student to practice writing their letters and numbers. While writing on paper, the student can easily reference any letter in the alphabet and numbers by looking at the perimeter around the center opening. As both sides of the enhance writer tool can have written insignia, the student can flip the tool depending on whether they wish to reference, for example, lower-case or upper-case letters.

### CROSS-REFERENCE TO RELATED APPLICATIONS

This non-provisional utility patent application claims the benefit of and priority to Provisional Application Ser. No. 62/868,374, filed Jun. 28, 2019, the entire contents of which is hereby incorporated herein by reference.

### BACKGROUND

There comes a point when young children grow and reach an age at which it is customary for them to learn the alphabet and the number system, such as for writing and visually recognizing alpha-numeric symbols. While most children are, eventually, able to properly learn and move on, the experience at the time can be daunting for the children and caregivers. Tools that can help ease the burden of learning the alphabet and number system can go a long way to expedite the child's learning and reduce the stress on the child and caregiver.

### SUMMARY

Implemented is an enhance writer tool that can be used for young children while learning to read and write alpha-numeric symbols. The enhance writer tool provides a relatively small area for the child to focus, which can be an asset for kids with learning disabilities. The enhance writer tool is a flat panel that has various alpha-numeric symbols written on both sides, a front and rear side. The enhance writer tool includes an opening in a center area that can be used for a student to practice writing their letters and numbers. While writing, the student can easily reference any letter in the alphabet and numbers by looking at the perimeter around the center opening. As both sides of the enhance writer tool can have written insignia, the student can flip the tool depending on whether they wish to reference, for example, lower-case or upper-case letters. While the enhance writer tool herein references various alpha-numeric elements, other learning mechanisms can also be written, such as mathematical symbols (e.g., subtraction sign, plus sign, equal sign, etc.), punctuation marks (e.g., exclamation point, question mark, semi-colon, percent symbol, ampersand, etc.), among other symbols.

The enhance writer tool provides a simple and easy mechanism for students to practice writing and learning the alphabet and numbers on their own, even without a caregiver present. As the enhance writer tool is, in typical implementations, plastic or some other durable material, the student can carry it around and re-use it such that the only additional tools the student needs are a writing tool and paper. Workbooks or work pages, on the other hand, can be bulky, easy to damage, and eventually be garbage when usable pages run out.

### BRIEF DESCRIPTION OF THE DRAWINGS

FIG. 1 shows an illustrative representation of a front side of the enhance writer tool;

FIG. 2 shows an illustrative representation of a rear side of the enhance writer tool;

FIG. 3 shows an illustrative representation of the enhance writer tool in use with finer lined paper; and

FIG. 4 shows an illustrative representation of the enhance writer tool in use with larger lined paper.

### DETAILED DESCRIPTION

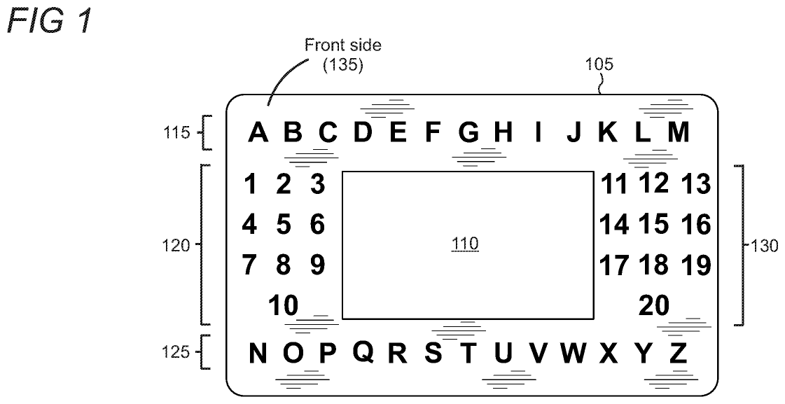

FIG. 1 shows an illustrative representation of the enhance writer tool 105. The enhance writer tool is comprised of a flat panel-like material with an opening 110 in a center area thereof. Although not shown, the flat panel may be anywhere from 1-5 centimeters wide, but thicker and thinner embodiments are also possible depending on the implementation. In typical implementations, the enhance writer tool may be comprised of a plastic material that is durable enough to withstand damage from, for example, dropping; however, other materials are also possible, such as paper, glass, metal, etc.

Along a perimeter of the opening 110 and on a surface of the front side 135 of the enhance writer tool 105 is insignia for reference for a user of the tool. In this illustrative example of the enhance writer tool, a beginning of the alphabet is positioned on an upper portion of the front side surface, as representatively shown by numeral 115. In the left middle and right middle portions of the tool, adjacent to the opening, are sequential numerals that count up to the number 20, as representatively shown by numerals 120 and 130. On a bottom portion of the tool is the latter half of the alphabet, as representatively shown by numeral 125. On the front side, the written alphabet is written using upper-case letters.

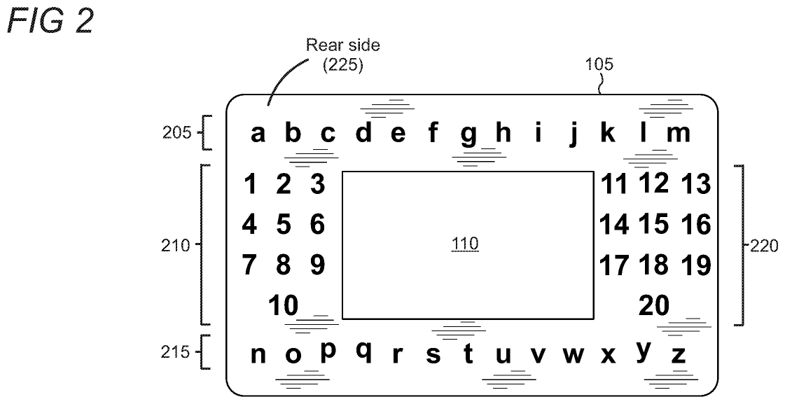

FIG. 2 shows an illustrative representation of a rear side 225 of the enhance writer tool 105. The opening 110 extends to and takes up the center area of the tool. Similar to the front side of the tool, the rear side has different sections of the alphabet on the upper portion and the bottom portion of the tool, as representatively shown by numerals 205 and 215. Similarly, numerals that count up to number 20 is positioned on left and right portions and adjacent to the opening 110, as representatively shown by numerals 210 and 220. In contrast to the front side, however, the alphabet on the rear side of the enhance writer tool is written using lower-case letters.

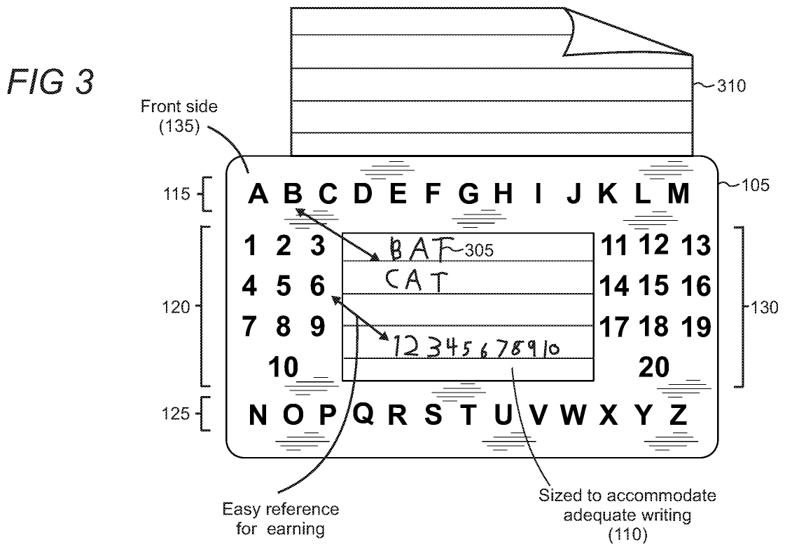

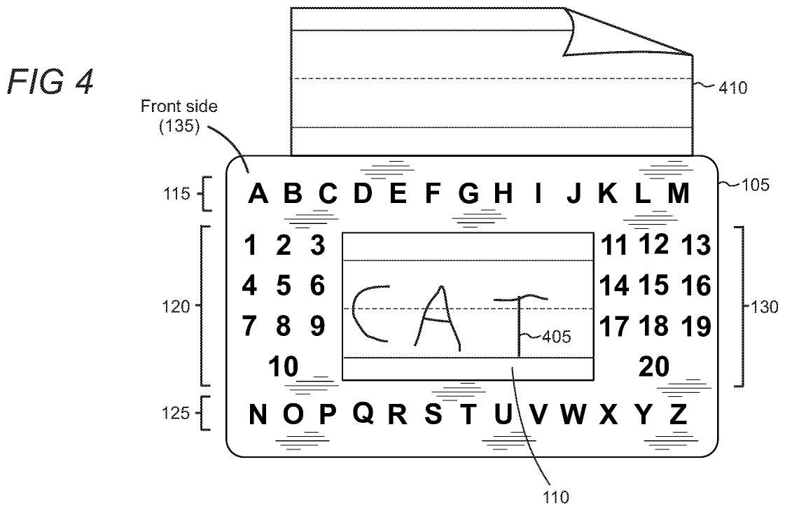

FIGS. 3 and 4 show illustrative representations of the enhance writer tool 105 in use scenarios in which finer line and larger line paper are used, respectively. A piece of paper 310 is positioned underneath the enhance writer tool. Both the paper and enhance writer tool may be lying flat on a table, desk, etc. (not shown). While the front side 135 of the tool is shown in this example, the same type of use is applicable to the rear side 225. The opening 110 for the enhance writer tool provides sufficient space for the piece of paper to be viewable and accessible by the user, such as a student. The student, while writing, can reference the letters and numbers around a perimeter of the opening, and thereby the paper, as shown by the writing represented by numeral 305. Furthermore, the opening is large enough to accommodate multiple lines of paper (FIG. 3) and writing for the student, so that they are not restricted to a particular line, but rather, can view at least some of their prior work and can extend outside the paper's lines if they wish while they practice writing and learning letters or numbers. FIG. 4, on the other hand, shows larger lined paper for young students who are just beginning learning their letters and numbers. While this tool can be used to learn to write legibly, it is particularly designed and crafted to teach a student how to write and identify particular symbols and elements, including letters in the alphabet, numbers, and, in other embodiments, mathematical symbols and other symbols. Although not shown, the enhance writer tool may come with some clip or other mechanism by which the paper can temporarily and removably attach to the tool to provide additional convenience to the user, such as by preventing the paper from moving, making the entire kit more portable, etc.

For younger children learning their number system and the alphabet, the enhance writer tool can provide a great benefit to the student so that they can look at each letter and number while writing. Furthermore, the student can see the letters in the conventional order in which people typically learn the alphabet, and the student can see the numbers in sequential order. This proper order can be another connection mechanism into the student's mind when learning. The enhance writer tool, therefore, can be used as a re-usable learning tool for students to read and write the alphabet and basic number system. The enhance writer tool can be used independently by a student so that if a parent or caregiver is not present, the student can still practice in their own time.

While the enhance writer tool herein references the various alpha-numeric elements, other learning mechanisms can also be written instead of or in addition to letters and numbers, such as mathematical symbols (e.g., subtraction sign, plus sign, equal sign, etc.), punctuation marks (e.g., exclamation point, question mark, semi-colon, percent symbol, ampersand, etc.), among other symbols.

Furthermore, the enhance writer tool 105 may be bigger or smaller depending on the specific implementation, For example, the enhance writer tool may be an inch or two larger or smaller, in which case the center opening 110 may likewise grow proportionately to the body of the tool itself, or may stay the same size. The insignia on the tool, such as the letters and/or numbers, may be in an array of different colors to stand out better for students as well, particularly those with learning disabilities who may be easily distracted. The colors may be broken be a rainbow assortment of colors, such as green, red, blue, purple, pink, etc. In some implementations, different colors may be used for different sections of the tool. For example, numbers may be one color or colors and the letters may be different color or colors from the numbers. This way, the user can easily reference and find the elements they want.

Various implementations and embodiments are disclosed herein. In one embodiment, disclosed is an enhance writer tool, comprising: a flat panel having an opening at a center portion thereof, the flat panel having a front side with insignia on its surface, wherein the insignia occupies an entire perimeter of the opening for reference to a user.

In another example, the opening in the enhance writing tool is sized to accommodate writing multiple lines on a piece of paper. As another example, the insignia includes an entire alphabet and numbers. As a further example, further comprising insignia on a rear side surface of the enhance writer tool, wherein the insignia on the rear side includes at least an alphabet in lower-case letters, and the alphabet on the front side surface is in upper-case letters. In another example, the alphabet and numbers are separated into segmented sections on the enhance writer tool. As another example, various colors are used for the insignia to enhance the appeal to the user's attention. In another example, different sections of the enhance writer tool utilize different color sets.

1. An enhance writer tool, comprising:
a flat panel having an opening at a center portion thereof, the flat panel having a front side with insignia on its surface, wherein the insignia occupies an entire perimeter of the opening for reference to a user.

2. The enhance writer tool of claim 1, wherein the opening in the enhance writing tool is sized to accommodate writing multiple lines on a piece of paper.

3. The enhance writer tool of claim 2, wherein the insignia includes an entire alphabet and numbers.

4. The enhance writer tool of claim 3, further comprising insignia on a rear side surface of the enhance writer tool, wherein the insignia on the rear side includes at least an alphabet in lower-case letters, and the alphabet on the front side surface is in upper-case letters.

5. The enhance writer tool of claim 4, wherein the alphabet and numbers are separated into segmented sections on the enhance writer tool.

6. The enhance writer tool of claim 5, wherein various colors are used for the insignia to enhance the appeal to the user's attention.

7. The enhance writer tool of claim 6, wherein different sections of the enhance writer tool utilize different color sets.
